(19) United States
(12) Patent Application Publication
(10) Pub. No.: US 2025/0200922 A1
(43) Pub. Date: Jun. 19, 2025

(54) ADJUSTING SPATIAL ELEMENTS

(71) Applicant: TENCENT TECHNOLOGY (SHENZHEN) COMPANY LIMITED, Shenzhen (CN)

(72) Inventors: Weizhe LIU, Shenzhen (CN); Pan JI, Shenzhen (CN); Hongdong LI, Shenzhen (CN)

(73) Assignee: TENCENT TECHNOLOGY (SHENZHEN) COMPANY LIMITED, Shenzhen, GD (CN)

(21) Appl. No.: 19/070,445

(22) Filed: Mar. 4, 2025

Related U.S. Application Data
(63) Continuation of application No. PCT/CN2023/129376, filed on Nov. 2, 2023.

(30) Foreign Application Priority Data
Jan. 29, 2023 (CN) 202310107786.6

(51) Int. Cl. G06T 19/20; G06T 5/50

(52) U.S. Cl. CPC G06T 19/20; G06T 5/50; G06T 2207/20221; G06T 2219/2004

(57) ABSTRACT

In a method for adjusting spatial elements, an environmental picture is displayed. The environmental picture includes a picture obtained by image acquisition of a scene region by an extended reality (XR) device. A first spatial element generated by three-dimensional layout recognition of the scene region is displayed based on the environmental picture. The first spatial element represents a three-dimensional simulation structure of a scene object in the scene region. An adjusted spatial layout element is displayed based on an adjustment operation on the first spatial element. The adjustment operation adjusts the three-dimensional simulation structure of the scene object. The adjusted spatial layout element is used to generate a three-dimensional virtual environment corresponding to the scene region in an XR application.

### RELATED APPLICATIONS

The present application is a continuation of International Application No. PCT/CN2023/129376, filed on Nov. 2, 2023, which claims priority to Chinese Patent Application No. 202310107786.6, filed on Jan. 29, 2023. The entire disclosures of the prior applications are hereby incorporated by reference.

### FIELD OF THE TECHNOLOGY

This application relates to the field of image processing, including a method for adjusting spatial elements.

### BACKGROUND OF THE DISCLOSURE

Scene layout estimation is a technology for determining scene layout information (for example, the sizes and positions of walls inside a house, etc.), which may be configured for assisting in the realization of technologies such as extended reality (XR).

In related art, after a user wears an XR device, the user may manually calibrate, in the process of displaying an environmental picture corresponding to a current user perspective, a spatial element corresponding to a scene object in the environmental picture by the XR device. For example, a vertex of a wall is calibrated. After the calibration is completed, the scene object may be modeled. For example, a spatial layout of the scene object in the environmental picture may be displayed.

However, in the related art, since the process of manually calibrating spatial elements is cumbersome and it is necessary to re-calibrate all spatial elements of the scene object when a calibration error occurs, the efficiency of determining an object layout in a scene is low.

### SUMMARY

Aspects of this disclosure provide a method, an apparatus, and a non-transitory computer-readable storage medium for adjusting spatial elements, which can improve the efficiency of determining an object layout in a scene. Examples of technical solutions of this disclosure may be implemented as follows:

An aspect of this disclosure provides a method for adjusting spatial elements. An environmental picture is displayed. The environmental picture includes a picture obtained by image acquisition of a scene region by an extended reality (XR) device. A first spatial element generated by three-dimensional layout recognition of the scene region is displayed based on the environmental picture. The first spatial element represents a three-dimensional simulation structure of a scene object in the scene region. An adjusted spatial layout element is displayed based on an adjustment operation on the first spatial element. The adjustment operation adjusts the three-dimensional simulation structure of the scene object. The adjusted spatial layout element is used to generate a three-dimensional virtual environment corresponding to the scene region in an XR application.

An aspect of this disclosure provides an information processing apparatus. The information processing apparatus includes processing circuitry configured to display an environmental picture. The environmental picture includes a picture obtained by image acquisition of a scene region by an extended reality (XR) device. The processing circuitry is configured to display a first spatial element generated by three-dimensional layout recognition of the scene region based on the environmental picture. The first spatial element represents a three-dimensional simulation structure of a scene object in the scene region. The processing circuitry is configured to display, based on an adjustment operation on the first spatial element, an adjusted spatial layout clement. The adjustment operation adjusts the three-dimensional simulation structure of the scene object. The adjusted spatial layout clement is used to generate a three-dimensional virtual environment corresponding to the scene region in an XR application.

An aspect of this disclosure provides a non-transitory computer-readable storage medium storing instructions which when executed by a processor cause the processor to perform any of the methods of this disclosure.

The technical solutions provided in this disclosure can include the following beneficial effects:

In the process of displaying an environmental picture obtained by image acquisition of a scene region by an XR device, three-dimensional layout recognition is first performed on the scene region to display a spatial layout element corresponding to an automatically generated scene object. When an adjustment operation on the spatial layout element is received, an adjusted spatial layout element is displayed, so that a three-dimensional virtual environment corresponding to the scene region can be generated by using the adjusted spatial layout element. On the one hand, by adjusting the spatial layout element automatically generated after three-dimensional layout recognition, an object within the region is prevented from being modeled from an initial state, thereby improving the efficiency of determining an object layout in a scene. On the other hand, the accuracy of a final object layout is improved by adjustment based on the automatically generated spatial layout element. In addition, in the process of XR application, the accuracy of the object layout in the scene is improved, and the scene realism of a finally generated three-dimensional virtual environment can also be improved.

### BRIEF DESCRIPTION OF THE DRAWINGS

FIG. 1 is a schematic diagram of an implementation environment according to an aspect of this disclosure.

FIG. 2 is a flowchart of a method for adjusting spatial elements according to an aspect of this disclosure.

FIG. 3 is a flowchart of a method for adjusting spatial elements according to another aspect of this disclosure.

FIG. 4 is a schematic diagram of a first spatial element according to an aspect of this disclosure.

FIG. 5 is a schematic diagram of an indoor scene according to an aspect of this disclosure.

FIG. 6 is a schematic diagram of a method for adjusting spatial nodes according to an aspect of this disclosure.

FIG. 7 is a schematic diagram of a method for adjusting spatial line segments according to an aspect of this disclosure.

FIG. 8 is a flowchart of a method for adjusting spatial elements according to still another aspect of this disclosure.

FIG. 9 is a schematic diagram of an XR device according to an aspect of this disclosure.

FIG. 10 is a schematic diagram of a three-dimensional virtual environment according to an aspect of this disclosure.

FIG. 11 is a schematic diagram of sound effect propagation according to an aspect of this disclosure.

FIG. 12 is a flowchart of a method for adjusting spatial elements according to yet another aspect of this disclosure.

FIG. 13 is a structural diagram of an apparatus for adjusting spatial elements according to an aspect of this disclosure.

FIG. 14 is a structural diagram of an apparatus for adjusting spatial elements according to another aspect of this disclosure.

FIG. 15 is a block diagram of a computer device according to an aspect of this disclosure.

### DETAILED DESCRIPTION

In this disclosure, a prompt interface or a pop-up window may be displayed, or voice prompt information may be outputted before collecting user-related data and when collecting user-related data. The prompt interface, the pop-up window, or the voice prompt information is configured for prompting the user that user-related data is currently being collected. In this way, in this disclosure, related operations of obtaining the user-related data only start to be executed after obtaining a confirmation operation of the user on the prompt interface or the pop-up window. Otherwise (to be specific, the confirmation operation of the user on the prompt interface or the pop-up window is not obtained), the related operations of obtaining the user-related data are ended. To be specific, the user-related data is not obtained.

Examples of terms involved in the aspects of the disclosure are briefly introduced. The descriptions of the terms are provided as examples only and are not intended to limit the scope of the disclosure.

Artificial intelligence (AI) is a theory, method, technology, and application system using a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

XR may refer to the combination of real and virtual through a computer to create a human-computer interactive virtual environment, and is a general term for augmented reality (AR), virtual reality (VR), mixed reality (MR), and other technologies. A visual interaction technology of AR, VR, and MR is implemented by a device, and “immersion” of seamless conversion between the virtual world and the real world is brought to an experiencer who wears the device, such as a VR head-mounted display (HMD), an AR HMD, or an MR HMD. The foregoing device may include a camera group composed of a plurality of cameras.

The solutions provided by the aspects of this disclosure relate to technologies such as computer vision and machine learning of AI. For example, a first image and a second image are processed by the computer vision. The aspects of this disclosure may be applied to an XR field. For example, when a user wears a head-mounted display device in a room and an XR application is running in the head-mounted display device, the head-mounted display device may acquire a picture of the room and generate a first spatial element of a scene region, which is convenient for the user to safely experience XR. XR may refer to the creation of a digital environment that combines real and virtual through modern scientific and technological means with a computer device as the core, and is a new type of human-computer interaction that may bring an immersion of seamless conversion and connection between the virtual world and the real world to a user. The XR technology may include AR, VR, MR, and other technologies.

FIG. 1 shows a schematic diagram of an implementation environment according to an aspect of this disclosure. The implementation environment may be implemented as an XR game system. As shown in FIG. 1, the system may include: a terminal device 11.

A target application, such as a client of the target application, is installed and run in the terminal device 11. The terminal device is an electronic device that has data computing, processing, and storage capabilities. The terminal device 11 may be a wearable device, such as a head-mounted display device, smart glasses, or XR glasses. The XR glasses may include AR glasses, MR glasses, VR glasses, and the like. The terminal device 11 may also be a handheld scanner, a smartphone, a tablet computer, a personal computer (PC), or the like. The aspects of this disclosure are not limited thereto. The target application may be any application having a function of determining three-dimensional layout information, such as an image processing application, a projection application, a social application, a payment application, a video application, a music application, a shopping application, a news application, or a game application. In the method provided in the aspects of this disclosure, each operation may be performed by the terminal device 11, for example, a client running in the terminal device 11.

In some aspects, the system further includes a server 12. The server 12 establishes a communication connection 13 (such as a network connection) with the terminal device 11. The server 12 is configured to provide a backend service for the target application. The server may be an independent physical server, may also be a server cluster or distributed system composed of a plurality of physical servers, and may also be a cloud server providing cloud computing services.

In the following description, the target application serves as an XR game application. In the process of displaying an environmental picture after image acquisition of a scene region, the terminal device 11 transmits a layout recognition request to the server 12 for requesting three-dimensional layout recognition of the scene region according to the environmental picture.

After receiving the layout recognition request, the server 12 performs three-dimensional layout recognition on the environmental picture in the layout recognition request, obtains a three-dimensional simulation structure of the scene object in the scene region, and feeds the three-dimensional simulation structure back to the terminal device 11 as a layout recognition result.

After receiving the layout recognition result, the terminal device 11 displays a first spatial element according to the three-dimensional simulation structure of the scene object in the layout recognition result. When the terminal device 11 receives an adjustment operation on the first spatial element, an element adjustment request is generated and transmitted to the server 12 for requesting adjustment of the first spatial element.

After receiving the element adjustment request, the server 12 adjusts the first spatial element to obtain a spatial layout element, and feeds an obtained element adjustment result back to the terminal device 11.

After receiving the element adjustment result, the terminal device 11 renders the environmental picture, displays the spatial layout element, and generates a three-dimensional virtual environment of the scene region according to the spatial layout element.

In some aspects, the environmental picture displayed in the terminal device 11 may be a real-time picture transmitted by another terminal device to the terminal device 11.

In combination with the foregoing term introduction and implementation environment, the method for adjusting spatial elements is introduced through the following aspects.

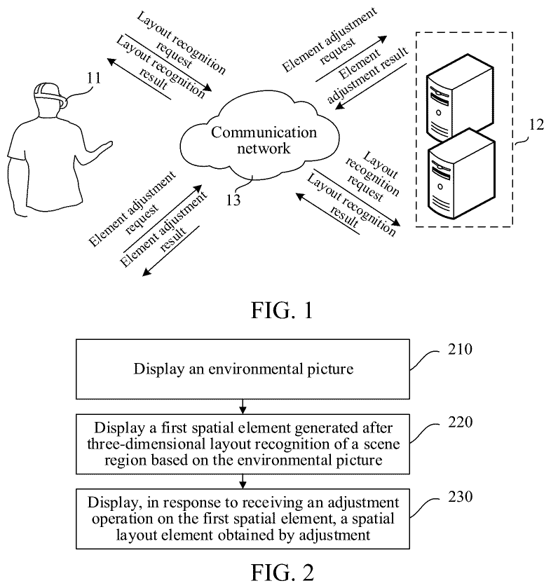

FIG. 2 schematically shows a flowchart of a method for adjusting spatial elements according to an example of an aspect of this disclosure. As shown in FIG. 2, the method includes the following operations.

Operation 210: Display an environmental picture. For example, an environmental picture is displayed. The environmental picture includes a picture obtained by image acquisition of a scene region by an extended reality (XR) device.

The environmental picture includes a picture obtained by image acquisition of a scene region by an XR device.

Schematically, the XR device includes at least one of a VR HMD, an AR HMD, an MR HMD, and other device types.

In some aspects, a user obtains an environmental picture corresponding to a scene region by image acquisition of the scene region at a specified angle using the XR device.

The specified angle may be determined according to factors such as a current position of the user, an orientation of a camera lens in the XR device, and a position of the XR device.

In some aspects, the environmental picture includes any one of a two-dimensional environmental picture or a three-dimensional environmental picture. When the environmental picture is implemented as a two-dimensional environmental picture, the environmental picture is obtained by ordinary image acquisition of the scene region through a camera in the XR device. Or, when the environmental picture is implemented as a three-dimensional environmental picture, the environmental picture is obtained by depth image acquisition of the scene region through a camera in the XR device. Or, when the environmental picture is implemented as a three-dimensional environmental picture, a two-dimensional image is first obtained by ordinary image acquisition of the scene region through a camera in the XR device, and a three-dimensional environmental picture corresponding to the scene region is then generated by image analysis based on the two-dimensional image.

In some aspects, the environmental picture corresponding to the scene region is directly displayed through a display screen configured in the XR device. Or, the XR device is connected to a peripheral device (for example, a projector), and the environmental picture corresponding to the scene region is displayed on a display screen of the peripheral device.

In an example, after a first environmental picture is obtained by image acquisition of the scene region through the XR device, when the position of the user holding the XR device is changed, the first environmental picture will be moved to a second environmental picture. To be specific, the environmental picture will also change in real time as the position of the user/XR device moves. Or, after a first environmental picture is obtained by image acquisition of the scene region through the XR device, when the position of the user holding the XR device is changed, the first environmental picture will not be changed. This is not limited.

In some aspects, the scene region is implemented as an indoor region. To be specific, the environmental picture is an indoor environmental picture. Or, the scene region is implemented as an outdoor region. To be specific, the environmental picture is an outdoor environmental picture. Or, the scene region is implemented as an indoor region and an outdoor region. To be specific, the environmental picture includes an indoor environmental picture and an outdoor environmental picture. This is not limited.

In some aspects, the foregoing environmental picture may be a picture obtained by image acquisition of the scene region through an XR device worn by another user.

In some aspects, the computer device (or terminal device) that displays the environmental picture refers to a first XR device worn by a first user. Real-time rendering data is received. The real-time rendering data is data obtained by image acquisition of the scene region by a second XR device worn by a second user. The environmental picture is displayed based on the real-time rendering data.

The first user and the second user are different users, and the first XR device and the second XR device are different devices. Schematically, user a wears XR glasses 1, an environmental picture corresponding to room A is acquired through XR glasses 1, the environmental picture is transmitted to XR glasses 2 worn by user b in real time through XR glasses 1, and XR glasses 2 may display the environmental picture, so that user b can remotely perform scene layout for room A on XR glasses 2.

In the foregoing aspects, the environmental picture can be a picture synchronized by another user through the XR device, thereby realizing a scene in which the spatial layout of the environmental picture is adjusted remotely. To be specific, the application scope of a spatial adjustment method is increased, so that the operation of modeling through the XR device is not limited to a scene in which the user currently acts, which may also be another real-time scene. In addition, remote spatial layout adjustment can also enable some users who are skilled in layout to assist users who are unfamiliar with layout, and improve the efficiency of spatial layout adjustment for users who are unfamiliar with layout.

The scene region includes at least one scene object.

Operation 220: Display a first spatial element generated after three-dimensional layout recognition of a scene region based on the environmental picture. For example, a first spatial element generated by three-dimensional layout recognition of the scene region is displayed based on the environmental picture. The first spatial element represents a three-dimensional simulation structure of a scene object in the scene region.

The first spatial element is configured for representing a three-dimensional simulation structure of a scene object in the scene region. In some aspects, three-dimensional layout recognition refers to analyzing the scene object in the scene region in a three-dimensional space to obtain a corresponding three-dimensional simulation structure in a case that the environmental picture is displayed. For example, the environmental picture is a concept of “two-dimensional plane”, the scene region is a concept of “three-dimensional space”, and three-dimensional layout recognition is a process of analyzing the scene object in the three-dimensional space through the two-dimensional plane. Or, the environmental picture is a “two-dimensional plane” having certain three-dimensional auxiliary information (for example, depth information acquired by a depth camera; or, multi-angle information acquired by a plurality of cameras), and three-dimensional layout recognition is a process of analyzing the scene object in the three-dimensional space through the two-dimensional plane and the three-dimensional auxiliary information.

In some aspects, the three-dimensional simulation structure of the scene object in the scene region may be configured to characterize a three-dimensional simulated spatial layout of the scene region. The three-dimensional simulated spatial layout refers to simulating a real layout of the scene object in the scene region in the environmental picture.

In some aspects, the simulated spatial layout includes at least one of position information of the scene object in the scene region, size information of the scene object in the scene region, orientation information of the scene object in the scene region, material information of the scene object in the scene region, and other information types.

In some aspects, the first spatial element refers to a two-dimensional information expression corresponding to the three-dimensional simulation structure of the scene object in the scene region, where the two-dimensional information expression includes at least one of a spatial node, a spatial line segment, a spatial plane, length data, angle data, and other expression types.

In some aspects, first spatial elements corresponding to different scene objects overlap. To be specific, first spatial element a belongs to both scene object A and scene object B. Or, first spatial elements corresponding to different scene objects do not overlap.

In some aspects, there is a television in the scene region, and simulated layout information of the television in the scene region includes position information of the television, size information of a display screen of the television, and a distance between the television and a camera lens in the XR device. Therefore, in the environmental picture, a vertex angle of the television is labeled with a spatial node (four vertex angles are labeled with four spatial nodes respectively), an edge of the television is labeled with a spatial line segment (four edge lines are labeled with four spatial line segments respectively), and the four spatial line segments are connected to generate a corresponding screen outline of the television, so as to obtain the size information of the display screen of the television. To be specific, in a scene picture, spatial nodes are connected to obtain spatial line segments, and the spatial line segments are connected to obtain a spatial plane.

In some aspects, all scene objects within the scene region are labeled with a first spatial element. Or, when a selection operation on a target scene object is received, a first spatial element of the target scene object is displayed.

In some aspects, the three-dimensional layout recognition is automatically performed on the scene region according to the environmental picture by the XR device. Or, the three-dimensional layout recognition is implemented by the user manually generating the first spatial element. For example, the user manually calibrates the first spatial element corresponding to the scene object through the XR device.

In some aspects, the scene object corresponds to a single first spatial element. For example, the scene object is labeled with a plurality of spatial nodes. Or, the scene object corresponds to a plurality of first spatial elements of different types. For example, the scene object is labeled with a plurality of spatial nodes, the plurality of spatial nodes are connected according to the outline of the scene object to obtain a plurality of spatial line segments, and a closed figure formed in the plurality of spatial line segments serves as a spatial plane corresponding to the scene object.

Operation 230: Display, in response to receiving an adjustment operation on the first spatial element, a spatial layout element obtained by adjustment. For example, an adjusted spatial layout element is displayed based on an adjustment operation on the first spatial element. The adjustment operation adjusts the three-dimensional simulation structure of the scene object. The adjusted spatial layout element is used to generate a three-dimensional virtual environment corresponding to the scene region in an XR application.

The adjustment operation is configured for adjusting a three-dimensional simulation structure of a scene object. The spatial layout element is configured for generating a three-dimensional virtual environment corresponding to the scene region in an application process of an XR technology.

In some aspects, the adjustment operation on the first spatial element includes at least one of addition/deletion of the first spatial element based on an existing first spatial element, adjustment of the position of the first spatial element, and other operation types.

Schematically, the spatial layout element is an element obtained by the adjustment operation on the first spatial element.

In some aspects, in an application process, the user has a layout requirement for the simulated spatial layout of the scene object in the application process. Therefore, the user performs the adjustment operation on the first spatial element so that the spatial layout element obtained by adjustment can meet the layout requirement.

In some aspects, through the three-dimensional layout recognition, besides the three-dimensional simulation structure of the scene object, a simulation region parameter of the scene region can also be recognized. To be specific, the first spatial element is further configured for indicating a simulation region parameter corresponding to the scene region, and the spatial layout element is further configured for indicating a simulation region parameter adjusted to adapt to layout requirements. The simulation region parameter includes at least one of parameters such as a simulation region area, a simulation region floor height, and a simulation region shape.

The simulation region area refers to a region area of the scene region recognized by the three-dimensional layout recognition method. For example, three-dimensional layout recognition is performed on an indoor scene region to obtain a scene region in which the area of the indoor scene region is 100 square meters. The simulation region height refers to a floor height of the scene region recognized by the three-dimensional layout recognition method. For example, three-dimensional layout recognition is performed on a peripheral region of a villa to obtain that the villa region has three floors. To be specific, the villa has three floors. The simulation region shape refers to a region shape of the scene region recognized by the three-dimensional layout recognition method. For example, three-dimensional layout recognition is performed on a bedroom scene region to obtain that the bedroom scene region is a rectangular scene region.

The simulation region parameter mentioned above refers to a measurement result of the region scene recognized by the three-dimensional layout recognition method, and does not refer to an actual region parameter in the scene region.

In some aspects, the layout requirement includes at least one of the following types of requirements:

1. Reduce the simulation region area of the scene region. For example, the area of a bedroom is reduced from 30 square meters to 15 square meters.

2. Reduce the simulation region floor height of the scene region. For example, a two-floor villa is adjusted to a one-floor villa.

3. Change the simulation region shape of the scene region. For example, a rectangular living room region is adjusted to a square living room region.

The foregoing layout requirements are merely an illustrative example, and the aspects of this disclosure are not limited thereto.

Then, an adjustment operation on the first spatial element is received. The adjustment operation is configured for reducing the simulation region area. The spatial layout element is displayed based on an area reduction magnitude indicated by the adjustment operation. Or, an adjustment operation on the first spatial element is received. The adjustment operation is configured for reducing the simulation region floor height. The spatial layout element is displayed based on a floor height reduction magnitude indicated by the adjustment operation. Or, an adjustment operation on the first spatial element is received. The adjustment operation is configured for changing a simulation region shape. The spatial layout element is displayed based on a modification manner indicated by the adjustment operation.

In one example, the scene region is an indoor scene region (100 square meters), but the user wants to perform activities only indoors of 50 square meters. The indoor scene region includes a scene object “wall”, and a first spatial element corresponding to the wall includes a wall line, a wall plane, and a wall corner. By reducing the area of the wall plane to half of an original area, the generated spatial layout element is implemented as a scene region of 50 square meters, so as to meet the layout requirement that the user can perform activities indoors of 50 square meters in the subsequent application process.

In one example, a spatial line segment at the highest point of a second floor in a scene object belonging to the wall of a two-floor villa is translated downwards to the highest point of a first floor by an adjustment operation, so that the simulation region floor height of the current villa is one.

In one example, the scene region is a square scene region, and the user adjusts the square scene region to a rectangular scene region by moving an edge line of the ground into the ground.

The simulation region area, the simulation region floor height, and the simulation region shape corresponding to the scene region obtained after the adjustment operation are only measurement data, and are unassociated with a real region area, a real region floor height, and a real region shape of the scene region.

In this aspect, in an XR application scene, the user performs the adjustment operation on the first spatial element so that a simulation space of the adjusted scene object is smaller than (or equal to) an actual scene region. In a case that the simulation space is smaller than the scene region, on the one hand, a buffer region can be divided between a virtual scene and an actual scene, so as to avoid some dangerous situations that may occur for the user on the boundary of the virtual scene and improve the safety of subsequent XR activities of the user in the scene region. On the other hand, the actual scene region may be divided into at least two regions, namely, a region where XR activities may be performed (simulated layout has been performed), and a region where XR activities cannot be performed temporarily (simulated layout has not been performed), thereby improving the diversity of regions within the scene region.

Schematically, since the first spatial element is a three-dimensional simulation structure generated after three-dimensional layout recognition, a spatial relationship of the scene object in a physical environment can only be simulated as much as possible. To be specific, the simulated spatial layout corresponding to a scene object currently represented by the first spatial element may be exactly the same as the spatial layout of the scene object in the actual scene region, or there may be certain deviations. The “spatial layout in the actual scene region” is the three-dimensional spatial layout. Therefore, in this aspect, the “simulated spatial layout” is a measurement result, and the “three-dimensional spatial layout” is a real result.

In some aspects, after the user performs the adjustment operation on the first spatial element corresponding to the scene object through the XR device, the spatial layout element corresponding to the scene object can be aligned with the three-dimensional spatial layout of the scene object in the physical environment. For example, when a spatial plane corresponding to a display screen of a television is obtained by three-dimensional layout recognition, but a plane size corresponding to the spatial plane is greater than an actual size of the display screen of the television in the scene region, the plane size corresponding to the adjusted spatial plane is equal to the actual size of the display screen of the television in the scene region by reducing the plane size of the spatial plane, and the adjusted spatial plane region is completely aligned with the display screen region of the television.

In some aspects, the three-dimensional spatial layout is displayed in the environmental picture corresponding to the scene region. Or, the three-dimensional spatial layout is not displayed in the environmental picture corresponding to the scene region. This is not limited.

In some aspects, after obtaining the spatial layout element corresponding to the scene object and applying the spatial layout element to XR technology, a three-dimensional virtual environment corresponding to the scene region may be generated. To be specific, the three-dimensional spatial layout of the scene object in the three-dimensional virtual environment is consistent with the adjusted simulated spatial layout. For example, if the scene region includes a television, a first spatial element corresponding to the television is adjusted to obtain an adjusted simulated spatial layout corresponding to the television. A finally generated three-dimensional virtual environment also includes the television, and a spatial layout corresponding to the television in the three-dimensional virtual environment is consistent with the simulated spatial layout.

In an implementable case, after the three-dimensional simulation structure of the scene object in the scene region is obtained by adjustment, a virtual object is mapped onto the scene object to generate a three-dimensional virtual environment including the virtual object and the scene object. For example, a virtual mural is mapped onto the wall, and the scene region also includes sofas and a television. To be specific, the finally generated three-dimensional virtual environment includes the virtual mural, the sofas, and the television.

In some aspects, the spatial layout corresponding to the finally generated three-dimensional virtual environment is consistent with the simulated spatial layout obtained by the adjustment operation in the process of picture display. Or, the spatial layout corresponding to the finally generated three-dimensional virtual environment is consistent with the simulated spatial layout obtained by the adjustment operation in the process of sound effect experience. For example, if the scene region is an open indoor region, an echo effect of the generated three-dimensional virtual environment is better, and if the scene region includes a plurality of scene objects, the echo effect of the generated three-dimensional virtual environment is poor.

In some aspects, the adjustment operation on the first spatial element refers to an operation recognized by an operation recognition device. Schematically, the operation recognition device may be implemented as a handheld sensor device. To be specific, a command indicated by an action of the user holding the sensor device is recognized by the action, and the adjustment operation on the first spatial element is triggered based on the command. Or, the operation recognition device may be implemented as a camera. To be specific, a command indicated by a gesture action of the user acquired by the camera is recognized by the gesture action, and the adjustment operation on the first spatial element is triggered based on the command. Or, the operation recognition device may be implemented as an audio acquisition device. To be specific, a command indicated by a sound of the user acquired by the audio acquisition device is recognized by the sound, and the adjustment operation on the first spatial element is triggered based on the command. The aspects of this disclosure are not limited thereto.

In conclusion, according to the method for adjusting spatial elements provided in the aspects of this disclosure, in the process of displaying an environmental picture obtained by image acquisition of a scene region by an XR device, three-dimensional layout recognition is first performed on the scene region to display a spatial layout element corresponding to an automatically generated scene object. When an adjustment operation on the spatial layout element is received, an adjusted spatial layout element is displayed, so that a three-dimensional virtual environment corresponding to the scene region can be generated by using the adjusted spatial layout element. On the one hand, by adjusting the spatial layout element automatically generated after three-dimensional layout recognition, an object within the region is prevented from being modeled from an initial state, thereby improving the efficiency of determining an object layout in a scene. On the other hand, the accuracy of a final object layout is improved by adjustment based on the automatically generated spatial layout element. In addition, in the process of XR application, the accuracy of the object layout in the scene is improved, and the scene realism of a finally generated three-dimensional virtual environment can also be improved.

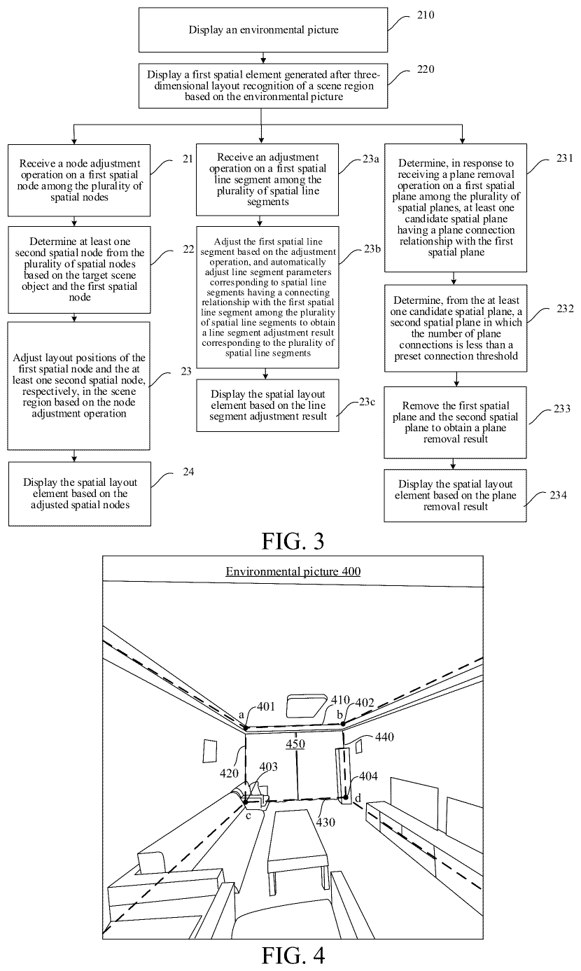

In some aspects, the first spatial element includes a plurality of spatial elements of different types. FIG. 3 schematically shows a flowchart of a method for adjusting spatial elements according to an aspect of this disclosure. To be specific, operation 230 includes operations 21 to 24, or includes operations 23a to 23c, or includes operations 231 to 234. As shown in FIG. 3, the method includes the following operations.

In this aspect, the first spatial element includes a spatial node, a spatial line segment, and a spatial plane. The three different types of first spatial elements will be described in detail below.

FIG. 4 schematically shows a schematic diagram of a first spatial element according to an aspect of this disclosure. As shown in FIG. 4, an environmental picture 400 is currently displayed. The environmental picture 400 is an indoor scene region. Therefore, the indoor scene region includes a plurality of walls serving as scene objects.

The environmental picture 400 includes wall A, where node a 401, node b 402, node c 403, and node d 404 are labeled. The four nodes are nodes corresponding to four corner vertices of wall A. In addition, node a 401 and node b 402 are connected to obtain a plane line segment ab 410, node a 401 and node c 403 are connected to obtain a plane line segment ac 420, node c 403 and node d 404 are connected to obtain a plane line segment cd 430, node d 404 and node b 402 are connected to obtain a plane line segment bd 440, and the plane line segment ab 410, the plane line segment ac 420, the plane line segment cd 430, and the plane line segment bd 440 are connected to obtain a spatial plane abcd 450.

### (1) Spatial Node

In this aspect, the first spatial element includes a plurality of spatial nodes corresponding to a target scene object in the scene region.

Operation 21: Receive a node adjustment operation on a first spatial node among the plurality of spatial nodes. For example, a node adjustment operation is received on a first spatial node of the plurality of spatial nodes.

The node adjustment operation is configured for indicating adjustment of the first spatial node.

In some aspects, the first spatial node is a spatial element of the plurality of spatial nodes. Or, the first spatial node does not belong to the plurality of spatial nodes.

In some aspects, the node adjustment operation includes at least one of addition of the first spatial node based on an existing spatial node, deletion of the first spatial node from the spatial nodes, change of a position of the first spatial node from the spatial nodes, and the like.

When the node adjustment operation is implemented as addition of the first spatial node, a second spatial node having a positional correspondence relationship with the first spatial node in the target scene object is added. When the node adjustment operation is implemented as deletion of the first spatial node, a second spatial node having a positional correspondence relationship with the first spatial node is deleted from the plurality of spatial nodes in the target scene object. When the node adjustment operation is implemented as change of the position of the first spatial node, a position of a second spatial node is changed. To be specific, the changed position of the first spatial node and the changed position of the second spatial node also have a positional binding relationship. The content of the positional binding relationship will be explained in detail in the subsequent operations, and will not be explained herein.

In some aspects, in the process of performing the node adjustment operation on the first spatial node, the second spatial node is adjusted in real time according to the process of adjusting the first spatial node as the first spatial node is adjusted. Or, in the process of performing the node adjustment operation on the first spatial node, after the first spatial node is adjusted, the second spatial node starts to be automatically adjusted.

Operation 22: Determine at least one second spatial node from the plurality of spatial nodes based on the target scene object and the first spatial node. For example, at least one second spatial node from the plurality of spatial nodes is determined based on the target scene object and the first spatial node. The at least one second spatial node has a positional binding relationship with the first spatial node that synchronizes adjustment of the at least one second spatial node with the first spatial node.

A positional binding relationship is present between the second spatial node and the first spatial node. The positional binding relationship is configured for indicating that the second spatial node is synchronously adjusted in the process of adjusting the first spatial node.

Before describing the positional binding relationship, a Manhattan world setting and a parallel setting will be described first.

### 1. Manhattan World Setting

In the Manhattan world setting, in a case that the scene region is an indoor scene, corners corresponding to all walls in the indoor scene are orthogonal to each other, and angles corresponding to the corners are ninety degrees.

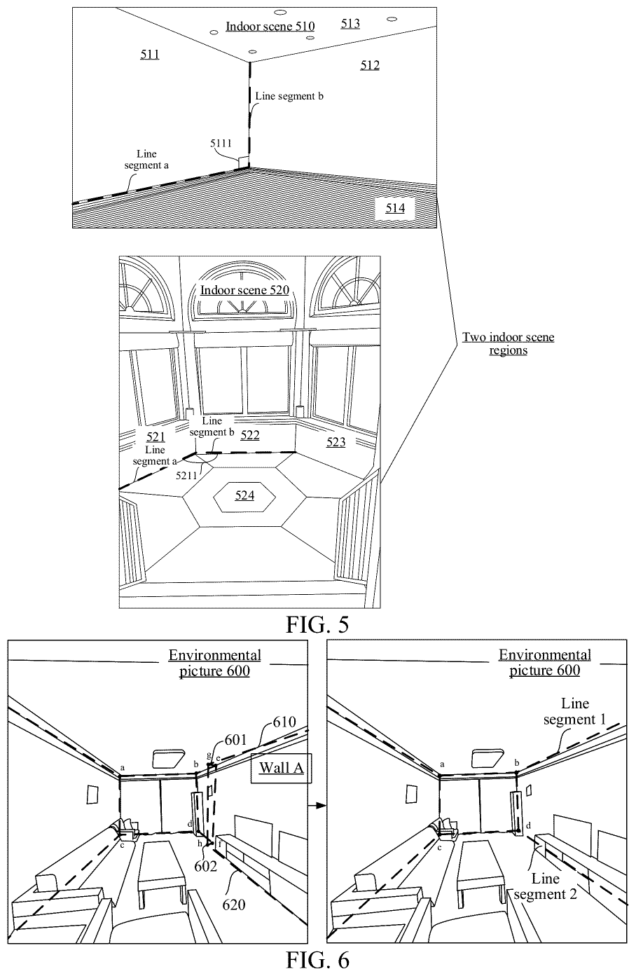

FIG. 5 schematically shows a schematic diagram of an indoor scene according to an aspect of this disclosure. Two different indoor scene regions, namely an indoor scene 510 and an indoor scene 520, are included.

In the indoor scene 510, a wall A 511, a wall B 512, a ceiling C 513, and a ground D 514 are displayed. In the example of the wall A 511, the wall A 511 borders the ground D 514 and also borders the wall B 512. Therefore, a corner 5111 is generated. Since line segment a corresponding to the wall A 511 bordering the ground D 514 (indicated by a dashed line in FIG. 5) and line segment b corresponding to the wall A 511 bordering the wall b 512 (indicated by a dashed line in FIG. 5) are in an orthogonal relationship, the corner 5111 is ninety degrees. Therefore, the indoor scene 510 conforms to the Manhattan world setting.

The indoor scene 520 shows a wall A 521, a wall B 522, a wall C 523, and a ground D 524. The wall A 521 and the wall B 522 respectively border the ground D 524. The wall A 521 and the ground D 524 border to obtain line segment a, the wall B 522 and the ground D 524 border to obtain line segment b, and line segment a and line segment b do not have an orthogonal relationship. Therefore, a corner 5211 formed by line segment a and line segment b is greater than ninety degrees. Therefore, the indoor scene 520 does not conform to the Manhattan world setting.

In an implementable case, the method provided by this disclosure performs three-dimensional layout recognition for a scene region conforming to the Manhattan World setting.

### 2. Parallel Setting

In the parallel setting, the scene region is, for example, an indoor scene region. A ceiling and a ground in the indoor scene region maintain a parallel relationship. Schematically, as shown in FIG. 4, in the environmental picture 400, each ceiling node (not labeled) on the ceiling has a corresponding ground node on the ground, and a distance between the corresponding ceiling node and the ground node is a floor height corresponding to a room in the indoor scene.

In an implementable case, the method provided by this disclosure performs three-dimensional layout recognition for a scene region conforming to the parallel setting.

In some aspects, a first spatial line segment corresponding to the first spatial node is determined based on the target scene object. Based on the target scene object and the plurality of spatial nodes, at least one second spatial line segment having a parallel relationship with the first spatial line segment is determined. The second spatial line segment includes at least one candidate spatial node among the plurality of spatial nodes. The second spatial node having a connecting relationship with the first spatial node is determined from the at least one candidate spatial node.

Schematically, the positional binding relationship means that the spatial line segments corresponding to the first spatial node and the second spatial node in the same scene object belong to a parallel relationship, and there is a connecting relationship between the first spatial node and the second spatial node.

In this aspect, deleting a first spatial node is described as an example. The first spatial node is the first spatial node in the target scene object.

In this aspect, a first spatial line segment where the first spatial node is located is determined according to the target scene object. For example, the target scene object is a wall, and wall line 1 where the first spatial node is located is determined, according to the wall, as the first spatial line segment. After obtaining a first spatial line segment, a second spatial line segment having a parallel relationship with the first spatial line segment is determined from the scene object. For example, wall line 1 is determined as the first spatial line segment according to the wall, and wall line 2 corresponding to the wall is determined as a second spatial line segment having a parallel relationship with wall line 1 according to the parallel setting and the Manhattan setting. At this moment, the second spatial line segment includes at least one candidate spatial node. The second spatial node having a connecting relationship with the first spatial node is determined from the at least one candidate spatial node according to the parallel setting.

FIG. 6 schematically shows a schematic diagram of a method for adjusting spatial nodes according to an aspect of this disclosure. As shown in FIG. 6, an environmental picture 600 is currently displayed. The environmental picture 600 includes a plurality of spatial nodes. When a deletion operation on node g 601 is received, node g serves as a first spatial node.

First, node g 601 is a node on wall A. Therefore, a line segment 610 corresponding to node g 601 on wall A is determined as a first spatial line segment. According to the Manhattan world setting and the parallel setting, a line segment 620 on wall A having a parallel relationship with the line segment 610 is determined as a second spatial line segment. Node h 602 having a connecting relationship with node g 601 is determined from at least one candidate spatial node corresponding to the second spatial line segment as a second spatial node. In this aspect, node e and node f also have a positional correspondence relationship.

Operation 23: Adjust layout positions of the first spatial node and the at least one second spatial node, respectively, in the scene region based on the node adjustment operation. For example, layout positions of the first spatial node and the at least one second spatial node in the scene region are adjusted based on the node adjustment operation.

In this aspect, the node adjustment operation is, for example, a deletion operation. The first spatial node is deleted according to the deletion operation, and the second spatial node having a positional correspondence relationship with the first spatial node is deleted. After the first spatial node and the second spatial node are deleted, layout information of the remaining spatial nodes in the scene region is automatically adjusted, where the layout information includes a connecting relationship between the remaining spatial nodes.

Schematically, as shown in FIG. 6, when node g 601 and node e are deleted, node h 602 having a positional correspondence relationship with node g 601 and node f having a positional correspondence relationship with node e are then deleted. After deleting the four nodes, the layout information of the remaining nodes a, b, c, and d within the scene region is automatically adjusted. To be specific, line segment 1 corresponding to node d and line segment 2 corresponding to node b are obtained by adjustment.

Operation 24: Display the spatial layout element based on the adjusted spatial nodes. For example, the adjusted spatial layout element is displayed based on the adjusted layout positions.

Schematically, as shown in FIG. 6, node a, node b, node c, and node d are currently displayed as spatial layout elements.

### (2) Spatial Line Segment

In this aspect, the first spatial element includes a plurality of spatial line segments corresponding to the scene object.

Operation 23a: Receive an adjustment operation on a first spatial line segment among the plurality of spatial line segments. For example, a line segment adjustment operation is received on a first spatial line segment of the plurality of spatial line segments.

Schematically, the adjustment operation includes at least one of operations of deleting a first spatial line segment among a plurality of spatial line segments, changing a length of the first spatial line segment, changing a line segment position of the first spatial line segment, and the like.

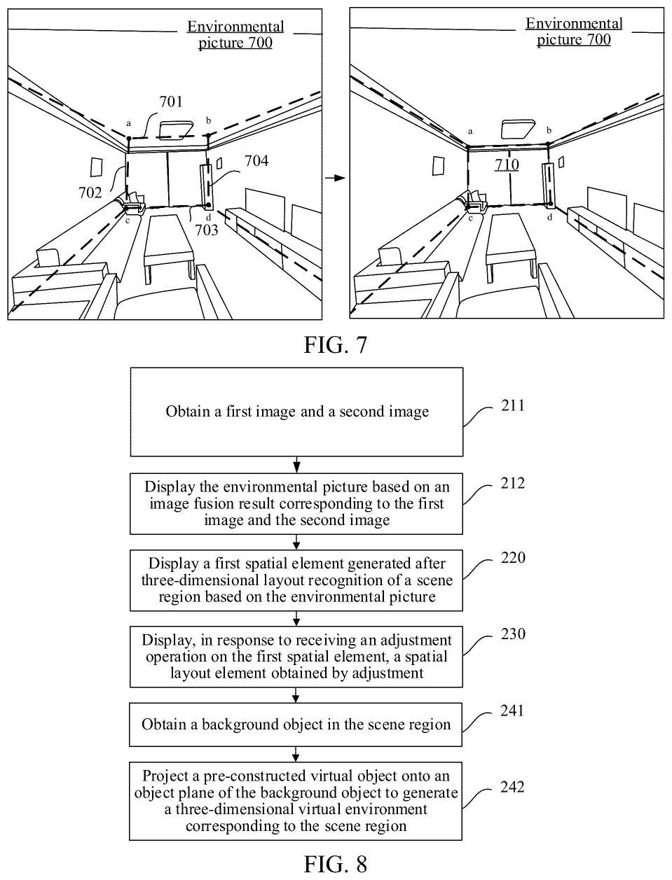

FIG. 7 schematically shows a schematic diagram of a method for adjusting spatial line segments according to an aspect of this disclosure. As shown in FIG. 7, an environmental picture 700 is currently displayed. The environmental picture 700 includes a plurality of spatial line segments, namely a spatial line segment ab 701 (indicated by a dashed line), a spatial line segment ac 702 (indicated by a dashed line), a spatial line segment cd 703 (indicated by a dashed line), and a spatial line segment db 704 (indicated by a dashed line).

The first spatial line segment is, for example, the spatial line segment ab 701. When a downward movement operation on the spatial line segment ab 701 is received, the line segment position of the spatial line segment ab 701 is moved downwards.

Operation 23b: Adjust the first spatial line segment based on the line segment adjustment operation, and automatically adjust line segment parameters corresponding to spatial line segments having a connecting relationship with the first spatial line segment among the plurality of spatial line segments to obtain a line segment adjustment result corresponding to the plurality of spatial line segments. For example, the first spatial line segment is adjusted based on the adjustment operation, and line segment parameters of connected spatial line segments are updated to generate a line segment adjustment result corresponding to the plurality of spatial line segments.

Schematically, the line segment parameter includes at least one of a line segment position of a spatial line segment, a line segment length of a spatial line segment, a connecting relationship between two spatial line segments, and other parameter types.

In some aspects, in the process of adjusting the first spatial line segment through the adjustment operation, line segment parameters of other spatial line segments having a connecting relationship with the first spatial line segment are adjusted in real time along with the process of adjusting the first spatial line segment. Or, after the adjustment of the first spatial line segment through the adjustment operation is completed, line segment parameters of other spatial line segments having a connecting relationship with the first spatial line segment are adjusted.

In this aspect, as shown in FIG. 7, when the spatial line segment ab 701 is adjusted to move downwards, the line segment lengths corresponding to the spatial line segment ac 702 and the spatial line segment db 704 are adjusted in real time, so that a line segment adjustment result 710 corresponding to the spatial line segment ab 701, the spatial line segment ac 702, the spatial line segment cd 703, and the spatial line segment db 704 is obtained. As can be seen from the line segment adjustment result 710, the line segment lengths corresponding to the adjusted spatial line segment ac 702 and spatial line segment db 704 are smaller than the line segment lengths corresponding to the unadjusted spatial line segment ac 702 and spatial line segment db 704.

Operation 23c: Display the spatial layout element based on the line segment adjustment result. For example, the adjusted spatial layout element is displayed based on the line segment adjustment result.

Schematically, as shown in FIG. 7, the adjusted spatial line segment ac 702, spatial line segment cd 703, and spatial line segment db 704 are displayed as spatial layout elements.

### (3) Spatial Plane

In this aspect, the first spatial element includes a plurality of spatial planes corresponding to the scene object.

Operation 231: Determine, in response to receiving a plane removal operation on a first spatial plane among the plurality of spatial planes, at least one candidate spatial plane having a plane connection relationship with the first spatial plane. For example, candidate spatial planes connected to the first spatial plane are determined based on a plane removal operation on a first spatial plane of the plurality of spatial planes is received.

The second spatial plane is connected with at least one spatial plane.

Schematically, the plane removal operation refers to deleting the first spatial plane from the plurality of spatial planes.

Schematically, further reference may be made to FIG. 7. A closed region obtained by connecting node g 701, node h 702, node e, and node f is a spatial plane ghfe (not labeled) as the first spatial plane. To be specific, a closed region obtained by connecting node a, node b, node c, and node d is a spatial plane abcd (not labeled).

In some aspects, the plane connection relationship refers to the presence of a connection portion between two spatial planes.

In this aspect, when the plane removal operation on the first spatial plane is received, it is determined that there is at least one candidate spatial plane (or there may be no candidate spatial plane) that connects with the first spatial plane.

Operation 232: Determine, from the at least one candidate spatial plane, a second spatial plane in which the number of plane connections is less than a preset connection threshold. For example, from the candidate spatial planes, a second spatial plane for which a number of plane connections is less than a connection threshold is determined.

Schematically, the number of plane connections refers to the number of spatial planes that have connection portions with the candidate plane space. For example, there are connection portions between plane a and plane b and between plane a and plane c. Therefore, the number of plane connections corresponding to plane a is 2.

In this aspect, when the number of plane connections corresponding to the second spatial plane is less than a preset connection threshold, it indicates that the second candidate spatial plane belongs to a deletable plane and thus serves as the second spatial plane. When the number of plane connections corresponding to the second spatial plane is greater than or equal to the preset connection threshold, it indicates that the second candidate spatial plane does not belong to a non-deletable plane and does not serve as the second spatial plane.

Operation 233: Remove the first spatial plane and the second spatial plane to obtain a plane removal result. For example, the first spatial plane and the second spatial plane are removed to obtain a plane removal result.

In this aspect, after the first spatial plane and the second spatial plane are determined (or the second spatial plane may not be present), the first spatial plane and the second spatial plane are deleted synchronously.

Operation 234: Display the spatial layout element based on the plane removal result. For example, the adjusted spatial layout element is displayed based on the plane removal result.

In this aspect, after the first spatial plane is deleted by the plane removal operation, the spatial plane abcd remains in the current spatial layout element.

The foregoing description of the operation of the three different types of first spatial elements is only a schematic example. In an implementable case, when a candidate node is adjusted, a spatial line segment and a spatial plane in which the candidate node is located will also be adjusted accordingly. To be specific, the spatial node, the spatial line segment, and the spatial plane have an association relationship. When any spatial element is adjusted, the corresponding other spatial elements will also be adjusted accordingly.

In this aspect, by adjusting the first spatial node, the second spatial node having a positional binding relationship with the first spatial node can be synchronously adjusted, thereby reducing the number of manual adjustments by the user and improving the efficiency of adjusting spatial elements. In addition, detailed contents in the layout can be adjusted by the adjustment of a single node, thereby improving the efficiency of adjusting spatial elements.

In this aspect, in the process of determining a second spatial node, a first spatial line segment corresponding to the first spatial node is first determined in the target scene object, a second spatial line segment having a parallel relationship with the first spatial line segment in the target scene object is then determined, and a second spatial node having a connecting relationship with the first spatial node is finally determined in the second spatial line segment. This progressive determination manner can ensure that the first spatial node and the second spatial node conform to the Manhattan world setting and the parallel setting, thereby improving the accuracy and rationality of spatial element adjustment.

In this aspect, by adjusting the first spatial line segment, a spatial line segment having a connecting relationship with the first spatial line segment is synchronously adjusted, thereby reducing the number of manual adjustments by the user. Moreover, compared with the adjustment of spatial nodes, the adjustment of the spatial line segment greatly changes the layout in a single adjustment, thereby improving the efficiency of adjusting spatial elements.

In this aspect, in the process of selecting a first spatial plane to be removed, a plurality of second spatial planes having a plane connection relationship with the first spatial plane are first determined, a second spatial plane in which the number of plane connections is less than a preset connection threshold is then determined from the plurality of second spatial planes, and the first spatial plane and the second spatial plane are finally deleted synchronously, thereby improving the accuracy of adjusting spatial elements. In addition, compared with the adjustment of the spatial nodes and the spatial line segments, the adjustment of the spatial plane greatly improves the change range of the layout in a single adjustment, thereby improving the accuracy of adjusting spatial elements.

In an aspect, three-dimensional layout recognition is implemented by a binocular camera in the XR device, where the binocular camera includes a first camera and a second camera. FIG. 8 schematically shows a flowchart of a method for adjusting spatial elements according to an aspect of this disclosure. To be specific, operation 210 further includes operations 211 to 212, and operation 230 is further followed by operations 241 and 242. The method includes the following operations.

Operation 211: Obtain a first image and a second image. For example, a first image and a second image are obtained. The first image and the second image are respectively obtained by the first camera and the second camera performing depth image acquisition on the scene region at the same time.

The first image and the second image are images respectively obtained by the first camera and the second camera performing depth image acquisition on the scene region at the same time.

In some aspects, the first camera and the second camera shoot the same scene region at the same time and at different positions, thereby obtaining the first image and the second image, respectively. To be specific, the first image and the second image are images captured at different angles of the scene region. The first image is captured by the first camera, and the second image is captured by the second camera.

In some aspects, the first camera and the second camera are disposed on the same device, and relative positions of the first camera and the second camera are fixed. In some aspects, when shooting the same scene, the relative positions of the first camera and the second camera are fixed. When shooting different scenes, a relative positional relationship between the first camera and the second camera may or may not be the same. The relative position of the first camera and the second camera may include a distance and a relative direction of the two cameras. In some aspects, the distance and relative direction between the first camera and the second camera are adjustable. For example, the distance between the first camera and the second camera may be increased or decreased. For another example, in a case that the first camera and the second camera are not at the same height, the first camera and the second camera may be adjusted to the same height by adjusting the height of the first camera and/or the second camera. In some aspects, a scale or other prompt information is present or may be displayed on the device for prompting the distance and relative direction between the first camera and the second camera.

In some aspects, the device may automatically generate recommendation information including a recommended relative position of the first camera and the second camera according to the size of the scene region, and transmit the recommendation information to the user. Thus, time required by the user to adjust the relative position of the first camera and the second camera is shortened, and the use convenience of the device is improved.

In some aspects, the device may be a head-mounted display device such as XR glasses or smart glasses.

In some aspects, the first image and the second image have the same image parameters. For example, the first image and the second image have the same image resolution. For another example, the first image and the second image have the same shape size. In some aspects, the first image and the second image also have the same shooting parameters such as respective camera types and focal lengths. Thus, feature fusion of the two images is facilitated, the accuracy of three-dimensional features obtained by fusion is improved, and the accuracy of three-dimensional layout information is further improved.

In some aspects, the first image and the second image have the same file format. The file formats of the first image and the second image may be a JPEG format, a TIFF format, a RAW format, a PNG format, a BMP format, an EXIF format, and the like, and the aspects of this disclosure are not specifically limited thereto.

Operation 212: Display the environmental picture based on an image fusion result corresponding to the first image and the second image. For example, the environmental picture is displayed based on an image fusion result corresponding to the first image and the second image.

Schematically, after the first image is obtained by the first camera and the second image is obtained by the second camera, an image position deviation between the first image and the second image is calculated to recover three-dimensional layout information of the scene object in the shot scene region, thereby obtaining an image fusion result of the first image and the second image, and further displaying the environmental picture corresponding to the scene region.

In some aspects, in the process of obtaining the environmental picture, a first spatial element corresponding to a three-dimensional simulation structure of the scene object in the scene region (the scene object is not displayed at this moment) is generated according to a relative position between the first camera and the second camera, respective shooting parameters of the first camera and the second camera, and the first image and the second image.

In this aspect, the three-dimensional simulation structure of the scene object is obtained by a pre-trained three-dimensional layout estimation model. The three-dimensional layout estimation model includes: a neural network encoder, a three-dimensional feature fusion device, and a neural network decoder.

The neural network encoder is configured to generate image features of the first image and image features of the second image.

The three-dimensional feature fusion device is configured to fuse the image features of the first image and the image features of the second image based on the relative position between the first camera and the second camera and the shooting parameters of the first camera and the second camera to generate three-dimensional features of the scene region.

In some aspects, the three-dimensional feature fusion device includes a first neural network and a second neural network. The first neural network is a neural network designed based on the principle of binocular disparity estimation, and the second neural network is a recurrent neural network. The first neural network is configured to fuse the image features of the first image and the image features of the second image to generate fused features of the first image and the second image. The second neural network is configured to generate three-dimensional features of the scene region according to the fused features of the first image and the second image.

In some aspects, the first neural network is a cost-volume network designed based on the principle of binocular disparity estimation. The cost-volume network represents a horizontal disparity search space in stereo matching, and is configured to measure the similarity of two views in binocular disparity estimation. In some aspects, the second neural network is a gate recurrent unit (GRU). The GRU may better capture the dependencies with large intervals in time series data, and may solve the gradient problem in long-term memory and back propagation. In some aspects, the first neural network generates fused features of the first image and the second image, which are divided into a plurality of feature blocks (such as 9 feature blocks). The feature blocks are sequentially inputted to the second neural network. The second neural network generates and saves hidden vectors by learning the feature blocks that have been inputted. After inputting a new feature block, features of the new feature block are fused with the saved hidden vectors to obtain updated hidden vectors. Once the features of all the feature blocks are learned, three-dimensional features of the scene region are generated.

The neural network decoder is configured to generate a simulated spatial layout of the scene region based on the three-dimensional features of the scene region, namely a three-dimensional simulation structure of the scene object. In some aspects, the neural network decoder is composed of a convolutional neural network and a fully connected layer.

In some aspects, the relative position includes a distance, and the shooting parameter includes a focal length. In some aspects, the first camera and the second camera have the same shooting parameters. For example, the first camera and the second camera have the same focal lengths. In some aspects, the first camera and the second camera have the same shooting parameters such as exposure compensations, aperture values, and shutter values.

Operation 220: Display a first spatial element generated after three-dimensional layout recognition of a scene region based on the environmental picture. For example, a first spatial element generated by three-dimensional layout recognition of the scene region is displayed based on the environmental picture. The first spatial element represents a three-dimensional simulation structure of a scene object in the scene region.

The first spatial element is configured for representing a three-dimensional simulation structure of a scene object in the scene region. In some aspects, the three-dimensional simulation structure of the scene object in the scene region may be configured to characterize a three-dimensional simulated spatial layout of the scene region.

Schematically, after the three-dimensional simulation structure of the scene object in the scene region is generated, the three-dimensional simulation structure needs to be rendered into the environmental picture, so as to display the first spatial element corresponding to the scene object. To be specific, it is necessary to convert three-dimensional layout information corresponding to the scene object into a two-dimensional information expression.

In some aspects, target inertial data is obtained. The target inertial data includes inertial data obtained by the XR device. A world coordinate system corresponding to the scene region is generated based on the first image, the second image, and the target inertial data. The world coordinate system includes three-dimensional space coordinates corresponding to the first spatial element. Coordinate conversion is performed on the three-dimensional space coordinates of the first spatial element based on a relative position between the first camera and the second camera and respective shooting parameters of the first camera and the second camera, to obtain two-dimensional plane coordinates corresponding to the three-dimensional space coordinates of the first spatial element. Picture rendering is performed on the environmental picture based on the two-dimensional plane coordinates, and the first spatial element is displayed.

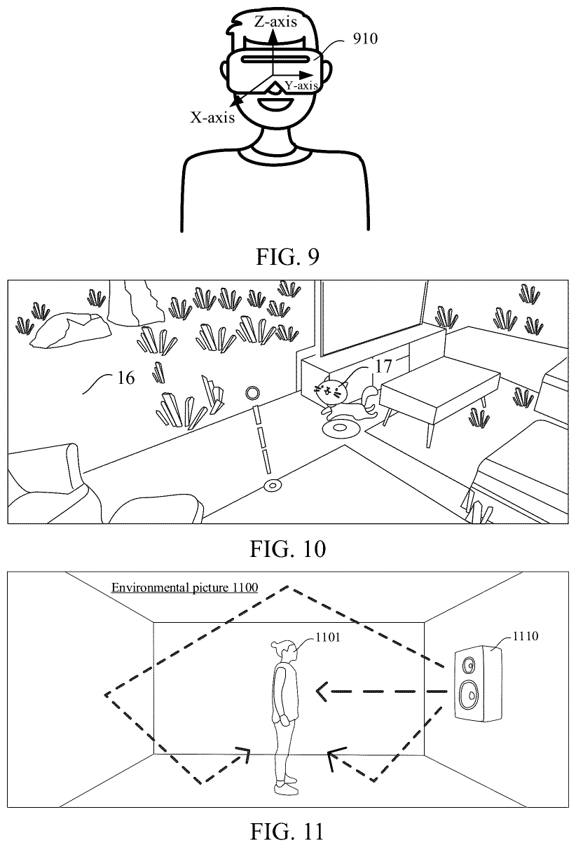

In this aspect, the XR device is, for example, a head-mounted device. FIG. 9 schematically shows a schematic diagram of an XR device according to an aspect of this disclosure. As shown in FIG. 9, an XR device 910 is currently displayed. The XR device 910 is implemented as XR glasses.

A simultaneous localization and mapping (SLAM) system is installed in the XR device, which converts three-dimensional simulation structures corresponding to different scene objects into the same world coordinate system.

Furthermore, an inertial measurement unit (IMU) for generating inertial data when a user shoots through the XR device is also installed in the XR device. The inertial data is configured for determining a gravity direction corresponding to the XR device so as to generate a world coordinate system corresponding to the XR device according to the gravity direction.

In the process of initializing the XR device, after a first image is obtained by a first camera and a second image is obtained by a second camera, the SLAM system determines the gravity direction corresponding to the XR device according to the inputted first image and second image and target inertial data generated by the IMU, and generates the world coordinate system. The world coordinate system includes an X-axis, a Y-axis, and a Z-axis. To be specific, the world coordinate system is a three-dimensional coordinate system. In the world coordinate system, the Y axis is aligned with an opposite direction corresponding to the gravity direction. As shown in FIG. 9, the X-axis, Y-axis, and Z-axis of the world coordinate system are currently displayed.

After obtaining the world coordinate system, three-dimensional space coordinates corresponding to a first spatial element corresponding to each scene object in a scene region can be determined according to an environmental picture. For example, a television includes vertex angle a, node a is labeled on vertex angle a, and three-dimensional space coordinates corresponding to node a are (2, 1, 3.5).

However, since the first spatial element cannot be directly displayed through the three-dimensional space coordinates at this moment, it is necessary to render the first spatial element. In the rendering process, three-dimensional space coordinates (X, Y, Z) corresponding to the first spatial element are converted into two-dimensional plane coordinates (U, V) in an image coordinate system, so that the first spatial element is rendered and displayed according to the two-dimensional plane coordinates. The coordinate conversion process may be performed with reference to Equation 1.

$$[ \begin{matrix}U \\ V \\ 1\end{matrix} ] = [ \begin{matrix}{f}_{x} & 0 & {C}_{x} & 0 \\ 0 & {f}_{y} & {CX}_{y} & 0 \\ 0 & 0 & 1 & 0\end{matrix} ] [ \begin{matrix}R t \\ {0}^{T} 1\end{matrix} ] \qquad Equation 1$$

where ƒₓ and ƒ_{y} are intersections of the first camera and the second camera, respectively, C_{z} and C_{y} are centers of corresponding imaging planes of the first image and the second image, respectively, and R and t are external parameters of the first camera and the second camera, respectively (namely, a rotation matrix and a translation matrix of the camera in the world coordinate system).

In this aspect, a first spatial element (a spatial node, a spatial line segment, and a spatial plane) corresponding to a scene object is projected into an environmental picture that can be viewed by a user through Equation 1 for rendering, and the first spatial element is finally displayed in the environmental picture.

Operation 241: Obtain a background object in the scene region. For example, a background object is obtained in the scene region.

Schematically, a spatial layout element corresponding to the scene object in the scene region is obtained, and a background object belonging to the background in the scene object is determined by object recognition of the scene object.

In one example, the scene region is an indoor scene region. The indoor scene region includes a wall, a ceiling, a ground, a sofa, a television, a coffee table, and other scene objects. After performing object recognition on the scene object, it is determined that the wall, the ceiling, and the ground belong to the background object.

Operation 242: Project a pre-constructed virtual object onto an object plane of the background object to generate a three-dimensional virtual environment corresponding to the scene region. For example, a virtual object is projected onto an object plane of the background object to generate the three-dimensional virtual environment corresponding to the scene region.

In some aspects, a virtual object or a virtual body adapted to the background object is constructed, and the constructed virtual object is projected onto an object plane of the background object, thereby displaying a three-dimensional virtual environment including the virtual object and the scene object. The virtual body may be a virtual creature. The virtual creature may be in a human form, an animal form, a cartoon form, or another form. The aspects of this disclosure are not limited thereto. The virtual body may also be a virtual object, such as a virtual toy, a virtual plant, or a virtual book. In some aspects, the virtual body may be a three-dimensional stereo model created based on an animated skeleton technology.

FIG. 10 schematically shows a schematic diagram of a three-dimensional virtual environment according to an aspect of this disclosure. As shown in FIG. 10, a virtual scene 16 may be projected and displayed on a wall according to the shape and size of each wall in a scene region, and a picture of the virtual scene 16 coincides with the wall of the scene region, and just covers the wall of the scene region. Furthermore, a virtual pet 17 may be displayed in the scene region, the virtual pet 17 is standing on the ground, and soles of the feet of the virtual pet are just fitted to the ground, so that it does not appear to be suspended in the air or extended below the ground.

In another implementable case, after obtaining the three-dimensional simulation structure of each scene object within the scene region, based on generating the three-dimensional virtual environment corresponding to the current scene region, an environmental sound effect of the three-dimensional virtual environment is synchronized with a physical sound effect within the scene region.

When sound propagates within the scene region, the sound effect will change due to different layouts and different object materials within the scene region. For example, when a user is differently distant from a door, the magnitudes of sound of closing and opening the door are different, and footsteps on a wooden floor and footsteps on a tile floor are also different.

In some aspects, an environmental sound effect corresponding to the three-dimensional virtual space is determined based on a distance between the scene object and the computer device and a material corresponding to the scene object. The environmental sound effect corresponding to the three-dimensional virtual space refers to an environmental sound effect adapted to a physical sound effect within the scene region.

Schematically, after obtaining the three-dimensional simulation structure of the scene object, a distance from a user (namely, a computer device, for example, an XR device worn by the user) to each scene object within the scene region and a material corresponding to each scene object can be recognized by the three-dimensional simulation structure. Therefore, in the process of experiencing the virtual environment, different spatial audio is configured for generating the environmental sound effect of the three-dimensional virtual environment to adapt to the physical sound effect within the scene region, so that the generated three-dimensional virtual scene is more realistic, thereby improving the user experience.

FIG. 11 schematically shows a schematic diagram of sound effect propagation according to an aspect of this disclosure. As shown in FIG. 11, an environmental picture 1100 corresponding to a scene region is currently displayed. A user 1101 is within the scene region at this moment. When a speaker 1110 within the scene region makes a sound, the sound will be propagated to the user 1101 through a plurality of paths, including: propagating to the user 1101 in a straight line, propagating to a ceiling and then to the user 1101 after multiple bounces, and propagating to the ground and then to the user 1101 after bouncing.

In this aspect, an environmental picture generated by a binocular camera can include depth information of each element in the picture, so that a three-dimensional simulation structure corresponding to a recognized scene object is more accurate, thereby reducing the number of adjustments by a user.

In this aspect, a world coordinate system is generated by target inertial data, so that three-dimensional space coordinates corresponding to the three-dimensional simulation structure of the scene object are converted into two-dimensional plane coordinates for rendering, thereby improving the display accuracy of a first spatial element.

In this aspect, a virtual object and the scene region are combined to generate a three-dimensional virtual scene, so that the generated three-dimensional virtual scene is more abundant, thereby improving the user experience.

In this aspect, based on a distance between the scene object and a computer device and a material corresponding to the scene object, different spatial audio is configured for generating an environmental sound effect of a three-dimensional virtual environment to adapt to a physical sound effect within the scene region, so that the generated three-dimensional virtual scene is more realistic, thereby improving the user experience.

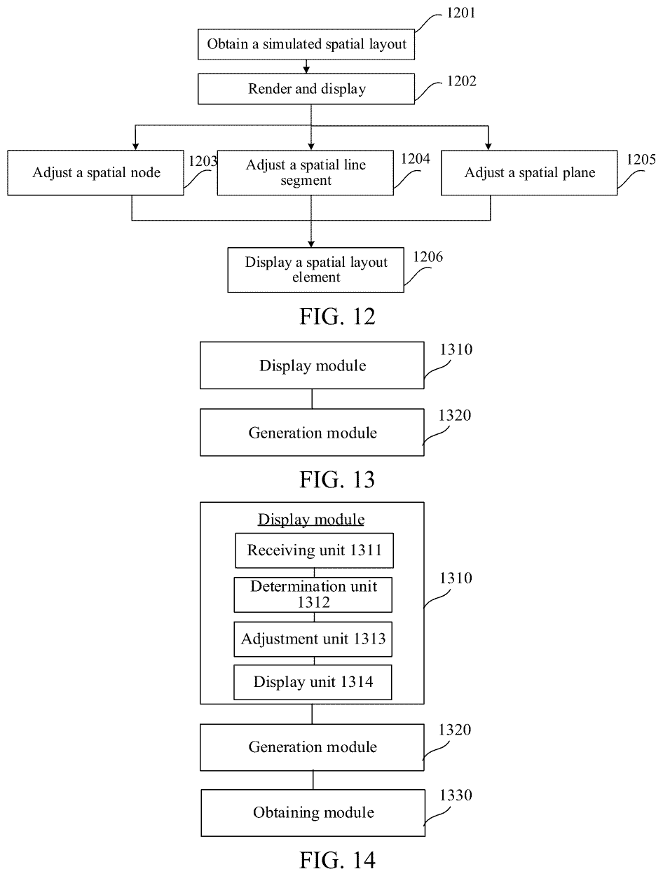

In an aspect, the application of the method for adjusting spatial elements to an XR game scene is described as an example. FIG. 12 schematically shows a flowchart of a method for adjusting spatial elements according to an aspect of this disclosure. As shown in FIG. 12, the method includes the following operations.

Operation 1201: Obtain a simulated spatial layout.

A first camera and a second camera in an XR device perform depth shooting on the same scene region at the same time, to obtain a first image and a second image corresponding to the scene region, respectively.

Schematically, after the first image is obtained by the first camera and the second image is obtained by the second camera, an image position deviation between the first image and the second image is calculated to recover three-dimensional layout information of the scene object in the shot scene region, thereby obtaining an image fusion result of the first image and the second image, and further displaying the environmental picture corresponding to the scene region.

In some aspects, in the process of obtaining the environmental picture, a first spatial element corresponding to a three-dimensional simulation structure of the scene object in the scene region (the scene object is not displayed at this moment) is generated according to a relative position between the first camera and the second camera, respective shooting parameters of the first camera and the second camera, and the first image and the second image. The first spatial element is configured for representing a simulated spatial layout.

In this aspect, the simulated spatial layout of the scene object is obtained by a pre-trained three-dimensional layout estimation model. The three-dimensional layout estimation model includes: a neural network encoder, a three-dimensional feature fusion device, and a neural network decoder.

Operation 1202: Render and display.

After obtaining the simulated spatial layout of the scene region, a rendering process of the simulated spatial layout is realized by a SLAM system and an IMU installed in the XR device.

First, the SLAM system determines a gravity direction corresponding to the XR device according to the inputted first image and second image and target inertial data generated by the IMU, thereby generating a world coordinate system. In the world coordinate system, a plurality of scene objects within the scene region are respectively provided with three-dimensional space coordinates, the three-dimensional space coordinates corresponding to the scene objects are converted into two-dimensional plane coordinates according to Equation 1, rendering is performed according to the two-dimensional plane coordinates corresponding to the scene objects, and first spatial elements corresponding to the scene objects are finally displayed.

Operation 1203: Adjust a spatial node.

In a case that the first spatial element includes a plurality of spatial nodes, when an adjustment operation on a first spatial node is received, a second spatial node having a positional correspondence relationship with the first spatial node is determined, and the second spatial node is adjusted in real time in the process of adjusting the first spatial node. After the first spatial node and the second spatial node are adjusted, the remaining candidate nodes are automatically adjusted to obtain a node adjustment result.

Operation 1204: Adjust a spatial line segment.

In a case that the first spatial element includes a plurality of spatial line segments, when an adjustment operation on a first spatial line segment is received, line segment parameters corresponding to spatial line segments having a connecting relationship with the first spatial line segment are adjusted in real time in the process of adjusting the first spatial line segment.

Operation 1205: Adjust a spatial plane.

In a case that the first spatial element includes a plurality of spatial planes, an adjustment operation on a first spatial plane is received.

Operation 1206: Display a spatial layout element.

After the adjusted spatial nodes/spatial line segments/spatial planes are obtained through the foregoing operations, the spatial layout element of the scene object within the scene region is displayed. In the process of displaying the spatial layout element, object recognition is performed on the scene object to obtain a background object, and a constructed virtual object is mapped onto an object plane of the background object to generate a three-dimensional virtual environment corresponding to the scene region, which is configured for a user to experience virtual interaction in the three-dimensional virtual environment when being within the scene region.

The method provided by this disclosure can make fine adjustments in an automatically predicted simulation layout according to actual needs of the user. Compared with a related manual manner, the method increases the speed greatly, and can improve the user experience greatly.

The foregoing three-dimensional layout recognition may serve as an interface to support various XR applications. For example, a virtual object is placed in a real scene, and a real object in the scene such as a ceiling and a wall are projected into a virtual scene to increase the field of view of the user.

The following describes apparatus aspects of this disclosure, which may be configured for executing the method aspects of this disclosure. Details not disclosed in the apparatus aspects of this disclosure may be similar to those in the method aspects of this disclosure.

FIG. 13 shows a block diagram of an apparatus for adjusting spatial elements according to an aspect of this disclosure. The apparatus has a function of implementing the examples of the method for adjusting spatial elements. The function may be implemented by hardware or may be implemented by hardware executing corresponding software. The apparatus may be the terminal device described above, or may be disposed on the terminal device.

A display module 1310 is configured to display an environmental picture. The environmental picture includes a picture obtained by image acquisition of a scene region by an XR device.

A generation module 1320 is configured to display a first spatial element generated after three-dimensional layout recognition of the scene region based on the environmental picture. The first spatial element is configured for representing a three-dimensional simulation structure of a scene object in the scene region.

The display module 1310 is further configured to display, in response to receiving an adjustment operation on the first spatial element, a spatial layout element obtained by adjustment. The adjustment operation is configured for indicating that the three-dimensional simulation structure of the scene object is adjusted. The spatial layout element is configured for generating a three-dimensional virtual environment corresponding to the scene region in an application process of an XR technology.

In some aspects, the first spatial element includes a plurality of spatial nodes corresponding to a target scene object in the scene region.

As shown in FIG. 14, the display module 1310 includes:
a receiving unit 1311, configured to receive a node adjustment operation on a first spatial node among the plurality of spatial nodes;
a determination unit 1312, configured to determine at least one second spatial node from the plurality of spatial nodes based on the target scene object and the first spatial node, where a positional binding relationship is present between the second spatial node and the first spatial node, and the positional binding relationship is configured for indicating that the second spatial node is synchronously adjusted in the process of adjusting the first spatial node;
an adjustment unit 1313, configured to adjust layout positions of the first spatial node and the at least one second spatial node, respectively, in the scene region based on the node adjustment operation; and
a display unit 1314, configured to display the spatial layout element based on the adjusted spatial nodes.

In some aspects, the determination unit 1312 is further configured to: determine a first spatial line segment corresponding to the first spatial node based on the target scene object; determine, based on the target scene object and the plurality of spatial nodes, at least one second spatial line segment having a parallel relationship with the first spatial line segment, where the second spatial line segment includes at least one candidate spatial node; and determine, from the at least one candidate spatial node, the second spatial node having a connecting relationship with the first spatial node.

In some aspects, the first spatial element includes a plurality of spatial line segments corresponding to the scene object.

The display module 1310 is further configured to: receive an adjustment operation on a first spatial line segment among the plurality of spatial line segments; automatically adjust, based on the adjustment operation, line segment parameters corresponding to spatial line segments having a connecting relationship with the first spatial line segment among the plurality of spatial line segments to obtain a line segment adjustment result corresponding to the plurality of spatial line segments; and display the spatial layout element based on the line segment adjustment result.

In some aspects, the first spatial element includes a plurality of spatial planes corresponding to the scene object.

The display module 1310 is further configured to: determine, in response to receiving a plane removal operation on a first spatial plane among the plurality of spatial planes, at least one candidate spatial plane having a plane connection relationship with the first spatial plane, where the candidate spatial plane is connected with at least one spatial plane; determine, from the at least one candidate spatial plane, a second spatial plane in which the number of plane connections is less than a preset connection threshold; remove the first spatial plane and the second spatial plane to obtain a plane removal result; and display the spatial layout element based on the plane removal result.

In some aspects, the XR device includes a first camera and a second camera.

The display module 1310 is further configured to: obtain a first image and a second image, the first image and the second image being images respectively obtained by the first camera and the second camera performing depth image acquisition on the scene region at the same time; and display the environmental picture based on an image fusion result corresponding to the first image and the second image.

In some aspects, the display module 1310 is further configured to: obtain target inertial data, where the target inertial data includes inertial data obtained by the XR device; generate a world coordinate system corresponding to the scene region based on the first image, the second image, and the target inertial data, where the world coordinate system includes three-dimensional space coordinates corresponding to the first spatial element; perform coordinate conversion on the three-dimensional space coordinates of the first spatial element based on a relative position between the first camera and the second camera and respective shooting parameters of the first camera and the second camera, to obtain two-dimensional plane coordinates corresponding to the three-dimensional space coordinates of the first spatial element; and perform picture rendering on the environmental picture based on the two-dimensional plane coordinates, and display the first spatial element.

In some aspects, the apparatus further includes:
an obtaining module 1330, configured to obtain a background object in the scene region.

The generation module 1320 is further configured to project a pre-constructed virtual object onto an object plane of the background object to generate a three-dimensional virtual environment corresponding to the scene region.

In some aspects, the generation module 1320 is further configured to determine an environmental sound effect corresponding to the three-dimensional virtual space based on a distance between the scene object and the computer device and a material corresponding to the scene object. The environmental sound effect corresponding to the three-dimensional virtual space refers to an environmental sound effect adapted to a physical sound effect within the scene region.

In some aspects, the first spatial element is further configured for indicating a simulation region parameter corresponding to the scene region, and the spatial layout element is further configured for indicating a simulation region parameter adjusted to adapt to layout requirements.

In some aspects, the simulation region parameter includes at least one of a simulation region area and a simulation region floor height. The display module 1310 is further configured to: receive an adjustment operation on the first spatial element, where the adjustment operation is configured for reducing the simulation region area; display the spatial layout element based on an area reduction magnitude indicated by the adjustment operation; or, receive an adjustment operation on the first spatial element, where the adjustment operation is configured for reducing the simulation region floor height; and display the spatial layout element based on a floor height reduction magnitude indicated by the adjustment operation.

In some aspects, the computer device refers to a first XR device worn by a first user. The display module 1310 is further configured to: receive real-time rendering data, where the real-time rendering data is data obtained by image acquisition of the scene region by a second XR device worn by a second user; and display the environmental picture based on the real-time rendering data.

In conclusion, according to the apparatus for adjusting spatial elements provided in the aspects of this disclosure, in the process of displaying an environmental picture obtained by image acquisition of a scene region by an XR device, three-dimensional layout recognition is first performed on the scene region to display a spatial layout element corresponding to an automatically generated scene object. When an adjustment operation on the spatial layout element is received, an adjusted spatial layout element is displayed, so that a three-dimensional virtual environment corresponding to the scene region can be generated by using the adjusted spatial layout element. On the one hand, by adjusting the spatial layout element automatically generated after three-dimensional layout recognition, an object within the region is prevented from being modeled from an initial state, thereby improving the efficiency of determining an object layout in a scene. On the other hand, the accuracy of a final object layout is improved by adjustment based on the automatically generated spatial layout element. In addition, in the process of XR application, the accuracy of the object layout in the scene is improved, and the scene realism of a finally generated three-dimensional virtual environment can also be improved.

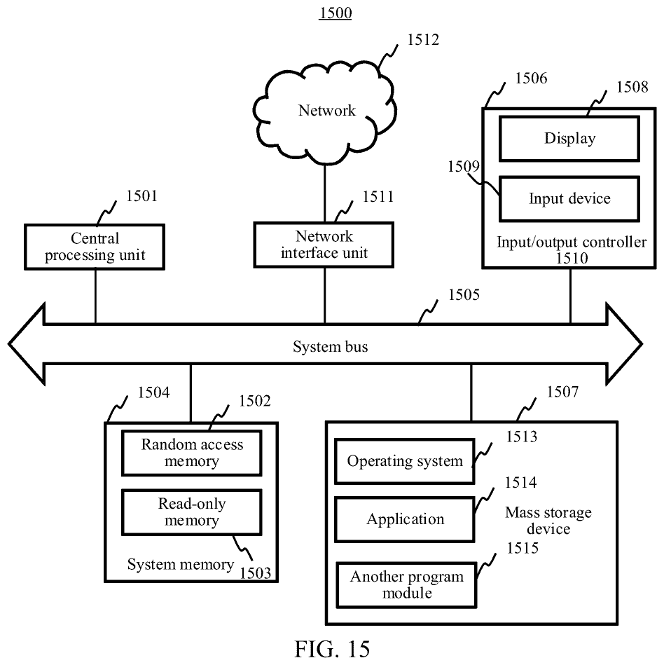

FIG. 15 shows a structural block diagram of a computer device according to an aspect of this disclosure. The computer device is configured to implement the method for adjusting spatial elements provided in the foregoing aspects. In an example,
the computer device 1500 includes a central processing unit (CPU) 1501 (e.g., processing circuitry), a system memory 1504 (e.g., a non-transitory computer-readable storage medium) including a random access memory (RAM) 1502 and a read-only memory (ROM) 1503, and a system bus 1505 connecting the system memory 1504 and the CPU 1501. The computer device 1500 further includes a basic input/output (I/O) system 1506 that facilitates transfer of information between elements within a computer, and a mass storage device 1507 that stores an operating system 1513, an application 1514, and another program module 1515.

The basic I/O system 1506 includes a display 1508 configured to display information and an input device 1509 such as a mouse or a keyboard for inputting information by a user. The display 1508 and the input device 15015 are connected to the CPU 1501 through an I/O controller 1510 which is connected to the system bus 1505. The basic I/O system 1506 may further include the I/O controller 1510 for receiving and processing input from a plurality of other devices, such as a keyboard, a mouse, or an electronic stylus. Similarly, the I/O controller 1510 also provides output to a display screen, a printer, or another type of output device.

The mass storage device 1507 is connected to the CPU 1501 through a mass storage controller (not shown) connected to the system bus 1505. The mass storage device 1507 and a computer-readable medium associated therewith provide non-volatile storage for the computer device 1500. To be specific, the mass storage device 1507 may include a computer-readable medium (not shown) such as a hard disk or a compact disc read-only memory (CD-ROM) drive.

Without loss of generality, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a RAM, a ROM, an erasable programmable read only memory (EPROM), an electrically erasable programmable read only memory (EEPROM), a flash memory or another solid state memory, a CD-ROM, a digital video disc (DVD) or another optical memory, a tape cartridge, a magnetic tape, a magnetic disk memory, or another magnetic storage device. Certainly, a person skilled in the art may learn that the computer storage medium is not limited to the foregoing several types. The foregoing system memory 1504 and mass storage device 1507 may be collectively referred to as a memory.

According to the aspects of this disclosure, the computer device 1500 may further be connected, through a network such as the Internet, to a remote computer on the network and run. To be specific, the computer device 1500 may be connected to a network 1512 by using a network interface unit 1511 connected to the system bus 1505, or may be connected to another type of network or a remote computer system (not shown) by using a network interface unit 1511.

In an aspect, a computer-readable storage medium is also provided. The storage medium stores a computer program. The computer program, when executed by a processor, implements the foregoing method for adjusting spatial elements.

In some aspects, the computer-readable storage medium may include: a ROM, a RAM, a solid state drive (SSD), an optical disc, or the like. The RAM may include a resistance random access memory (ReRAM) and a dynamic random access memory (DRAM).

In an aspect, a computer program product is also provided. The computer program product includes a computer program. The computer program is stored in a computer-readable storage medium, such as a non-transitory computer-readable storage medium. A processor of a computer device reads the computer program from the computer-readable storage medium. The processor executes the computer program, to cause the computer device to perform the foregoing method for adjusting spatial elements.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for adjusting spatial elements, the method comprising:
displaying an environmental picture, the environmental picture including a picture obtained by image acquisition of a scene region by an extended reality (XR) device;
displaying a first spatial element generated by three-dimensional layout recognition of the scene region based on the environmental picture, the first spatial element representing a three-dimensional simulation structure of a scene object in the scene region; and
displaying, based on an adjustment operation on the first spatial element, an adjusted spatial layout element, the adjustment operation adjusting the three-dimensional simulation structure of the scene object, the adjusted spatial layout element being used to generate a three-dimensional virtual environment corresponding to the scene region in an XR application.

2. The method according to claim 1, wherein the first spatial element includes a plurality of spatial nodes corresponding to a target scene object in the scene region; and
the displaying the adjusted spatial layout element comprises:
receiving a node adjustment operation on a first spatial node of the plurality of spatial nodes;
determining at least one second spatial node from the plurality of spatial nodes based on the target scene object and the first spatial node, the at least one second spatial node having a positional binding relationship with the first spatial node that synchronizes adjustment of the at least one second spatial node with the first spatial node;
adjusting layout positions of the first spatial node and the at least one second spatial node in the scene region based on the node adjustment operation; and
displaying the adjusted spatial layout element based on the adjusted layout positions.

3. The method according to claim 2, wherein the determining the at least one second spatial node comprises:
identifying a first spatial line segment corresponding to the first spatial node based on the target scene object;
determining at least one second spatial line segment parallel to the first spatial line segment, the at least one second spatial line segment including candidate spatial nodes from the plurality of spatial nodes; and
selecting the at least one second spatial node from the candidate spatial nodes based on a connection relationship with the first spatial node.

4. The method according to claim 1, wherein the first spatial element includes a plurality of spatial line segments corresponding to the scene object; and
the displaying the adjusted spatial layout element comprises:
receiving a line segment adjustment operation on a first spatial line segment of the plurality of spatial line segments;
adjusting the first spatial line segment based on the line segment adjustment operation, and updating line segment parameters of connected spatial line segments to generate a line segment adjustment result corresponding to the plurality of spatial line segments; and
displaying the adjusted spatial layout element based on the line segment adjustment result.

5. The method according to claim 1, wherein the first spatial element includes a plurality of spatial planes corresponding to the scene object; and
the displaying the adjusted spatial layout element comprises:
determining, based on a plane removal operation on a first spatial plane of the plurality of spatial planes is received, candidate spatial planes connected to the first spatial plane;
determining, from the candidate spatial planes, a second spatial plane for which a number of plane connections is less than a connection threshold;
removing the first spatial plane and the second spatial plane to obtain a plane removal result; and
displaying the adjusted spatial layout element based on the plane removal result.

6. The method according to claim 1, wherein the XR device includes a first camera and a second camera; and
the displaying the environmental picture comprises:
obtaining a first image and a second image, the first image and the second image being respectively obtained by the first camera and the second camera performing depth image acquisition on the scene region at the same time; and
displaying the environmental picture based on an image fusion result corresponding to the first image and the second image.

7. The method according to claim 6, wherein the displaying the first spatial element comprises:
obtaining target inertial data, the target inertial data including inertial data obtained by the XR device;
generating a world coordinate system corresponding to the scene region based on the first image, the second image, and the target inertial data, the world coordinate system including three-dimensional space coordinates corresponding to the first spatial element;
performing coordinate conversion on the three-dimensional space coordinates of the first spatial element based on (i) a relative position between the first camera and the second camera and (ii) respective shooting parameters of the first camera and the second camera, to obtain two-dimensional plane coordinates corresponding to the three-dimensional space coordinates of the first spatial element; and
rendering the environmental picture based on the two-dimensional plane coordinates to display the first spatial element.

8. The method according to claim 1, further comprising:
obtaining a background object in the scene region; and
projecting a virtual object onto an object plane of the background object to generate the three-dimensional virtual environment corresponding to the scene region.

9. The method according to claim 8, further comprising:
determining an environmental sound effect corresponding to the three-dimensional virtual environment based on (i) a distance between the scene object and the XR device and (ii) a material corresponding to the scene object.

10. The method according to claim 1, wherein the first spatial element indicates a simulation region parameter corresponding to the scene region, and the adjusted spatial layout element indicates a modified simulation region parameter adjusted to meet layout requirements.

11. The method according to claim 10, wherein the simulation region parameter includes at least one of a simulation region area and a simulation region floor height; and
the displaying the adjusted spatial layout element comprises:
when the adjustment operation on the first spatial element is to reduce the simulation region area, displaying the adjusted spatial layout element based on an area reduction magnitude indicated by the adjustment operation; and
when the adjustment operation on the first spatial element is to reduce the simulation region floor height, displaying the adjusted spatial layout element based on a floor height reduction magnitude indicated by the adjustment operation.

12. The method according to claim 1, wherein the XR device is a first XR device worn by a first user; and
the displaying the environmental picture comprises:
receiving real-time rendering data from a second XR device worn by a second user, the second XR device performing the image acquisition on the scene region; and
displaying the environmental picture based on the real-time rendering data.

13. An information processing apparatus, comprising:
processing circuitry configured to:
display an environmental picture, the environmental picture including a picture obtained by image acquisition of a scene region by an extended reality (XR) device;
display a first spatial element generated by three-dimensional layout recognition of the scene region based on the environmental picture, the first spatial element representing a three-dimensional simulation structure of a scene object in the scene region; and
display, based on an adjustment operation on the first spatial element, an adjusted spatial layout element, the adjustment operation adjusting the three-dimensional simulation structure of the scene object, the adjusted spatial layout element being used to generate a three-dimensional virtual environment corresponding to the scene region in an XR application.

14. The information processing apparatus according to claim 13, wherein the first spatial element includes a plurality of spatial nodes corresponding to a target scene object in the scene region; and
the processing circuitry is further configured to:
receive a node adjustment operation on a first spatial node of the plurality of spatial nodes;
determine at least one second spatial node from the plurality of spatial nodes based on the target scene object and the first spatial node, the at least one second spatial node having a positional binding relationship with the first spatial node that synchronizes adjustment of the at least one second spatial node with the first spatial node;
adjust layout positions of the first spatial node and the at least one second spatial node in the scene region based on the node adjustment operation; and
display the adjusted spatial layout element based on the adjusted layout positions.

15. The information processing apparatus according to claim 14, wherein the processing circuitry is configured to:
identify a first spatial line segment corresponding to the first spatial node based on the target scene object;
determine at least one second spatial line segment parallel to the first spatial line segment, the at least one second spatial line segment including candidate spatial nodes from the plurality of spatial nodes; and
select the at least one second spatial node from the candidate spatial nodes based on a connection relationship with the first spatial node.

16. The information processing apparatus according to claim 13, wherein the first spatial element includes a plurality of spatial line segments corresponding to the scene object; and
the processing circuitry is further configured to:
receive a line segment adjustment operation on a first spatial line segment of the plurality of spatial line segments;
adjust the first spatial line segment based on the line segment adjustment operation, and update line segment parameters of connected spatial line segments to generate a line segment adjustment result corresponding to the plurality of spatial line segments; and
display the adjusted spatial layout element based on the line segment adjustment result.

17. The information processing apparatus according to claim 13, wherein
the first spatial element includes a plurality of spatial planes corresponding to the scene object; and
the processing circuitry is further configured to:
determine, based on a plane removal operation on a first spatial plane of the plurality of spatial planes is received, candidate spatial planes connected to the first spatial plane;
determine, from the candidate spatial planes, a second spatial plane for which a number of plane connections is less than a connection threshold;
remove the first spatial plane and the second spatial plane to obtain a plane removal result; and
display the adjusted spatial layout element based on the plane removal result.

18. The information processing apparatus according to claim 13, wherein the XR device includes a first camera and a second camera; and
the processing circuitry is further configured to:
obtain a first image and a second image, the first image and the second image being respectively obtained by the first camera and the second camera performing depth image acquisition on the scene region at the same time; and
display the environmental picture based on an image fusion result corresponding to the first image and the second image.

19. The information processing apparatus according to claim 18, wherein the processing circuitry is configured to:
obtain target inertial data, the target inertial data including inertial data obtained by the XR device;
generate a world coordinate system corresponding to the scene region based on the first image, the second image, and the target inertial data, the world coordinate system including three-dimensional space coordinates corresponding to the first spatial element;
perform coordinate conversion on the three-dimensional space coordinates of the first spatial element based on (i) a relative position between the first camera and the second camera and (ii) respective shooting parameters of the first camera and the second camera, to obtain two-dimensional plane coordinates corresponding to the three-dimensional space coordinates of the first spatial element; and
render the environmental picture based on the two-dimensional plane coordinates to display the first spatial element.

20. A non-transitory computer-readable storage medium storing instructions which, when executed by a processor, cause the processor to perform:
displaying an environmental picture, the environmental picture including a picture obtained by image acquisition of a scene region by an extended reality (XR) device;
displaying a first spatial element generated by three-dimensional layout recognition of the scene region based on the environmental picture, the first spatial element representing a three-dimensional simulation structure of a scene object in the scene region; and
displaying, based on an adjustment operation on the first spatial element, an adjusted spatial layout element, the adjustment operation adjusting the three-dimensional simulation structure of the scene object, the adjusted spatial layout element being used to generate a three-dimensional virtual environment corresponding to the scene region in an XR application.
